(19) United States
(12) Patent Application Publication
(10) Pub. No.: US 2016/0198022 A1
(43) Pub. Date: Jul. 7, 2016

(54) SYSTEM, METHOD AND DEVICE FOR PROVIDING DEVICE DATA TO A SERVER IN A NETWORK

(71) Applicant: YANDEX EUROPE AG, Luzern (CH)

(72) Inventors: Vladimir Stanislavovich IVANOV, Akatovo, Smolensk region (RU); Mikhail Robertovich NAZARGULOV, Dubnai, Moscow Region (RU); Dmitry Viktorovich AFANASIEV, Krasnogorsk, Moscow region (RU)

(21) Appl. No.: 14/916,928

(22) PCT Filed: Jul. 4, 2014
(86) PCT No.: PCT/IB2014/062874

§ 371 Date: Mar. 4, 2016

(30) Foreign Application Priority Data
Dec. 30, 2013 (RU) 2013158632

(51) Int. Cl. H04L 29/06

(52) U.S. Cl. CPC H04L 69/163

(57) ABSTRACT

A method of providing device data relating to a device is disclosed. The method comprising identifying device data associated with the device, compiling a network protocol layer message associated with the communication device, the network protocol layer message having a plurality of network protocol layer fields, a first subset of the plurality of network protocol fields being non-encrypted and a second subset of the plurality of network protocol fields being encrypted; and inserting the device data into at least one of said first subset of the plurality of the network protocol layer fields, said inserting enabling incorporation of the device data into the encrypted network layer message.

### CROSS-REFERENCE

The present application claims convention priority to Russian Utility Patent Application No. 2013158632, filed on Dec. 30, 2013, entitled “ [symbol] [symbol] [symbol] [symbol] ( [symbol] ), [symbol] [symbol] [symbol] [symbol] [symbol] [symbol] [symbol] [symbol] [symbol] ”. This application is incorporated by reference herein in its entirety.

### FIELD OF THE DISCLOSURE

The field for the present disclosure relates to a system, a method and a device for providing device data to a server in a network.

### BACKGROUND OF THE DISCLOSURE

In a network, a client device communicates with a server. Data and messages are continually sent between the client device and the server. Prior art systems provide configuration data about the client device in Hypertext Transfer Protocol (HTTP) messages to web servers. Where Hypertext Transfer Protocol Secure (HTTPS) messages are sent, data is encrypted, making it difficult to extract, add or change data in the message.

### SUMMARY OF THE DISCLOSURE

It is an object of the present technology to ameliorate at least some of the inconveniences present in the prior art.

According to a first broad aspect of the present technology, there is provided a method of providing device data relating to a device. The method comprises identifying device data associated with the device, compiling a network protocol layer message associated with the communication device, the network protocol layer message having a plurality of network protocol layer fields, a first subset of the plurality of network protocol fields being non-encrypted and a second subset of the plurality of network protocol fields being encrypted; and inserting the device data into at least one of the first subset of the plurality of the network protocol layer fields, the inserting enabling incorporation of the device data into the encrypted network layer message.

In some implementations of the technology, the transport layer message is a TCP SYN message. In some implementations of the technology, at least one of the first subset of the plurality of the network protocol layer fields is a TCP Options field.

In some implementations of the technology, the method further comprises segregating the TCP Options field into a plurality of sub-fields each of the plurality of sub-fields being reserved for specific portion of the device data.

In some implementations of the technology, data in the TCP Options field is prepended with an identification label for the device data.

In some implementations of the technology, compiling comprises inserting a portion of the device data into the network protocol layer message, the method further comprising generating a second network protocol layer message containing a remainder of the device data.

In some implementations of the technology, the method being executed at the device. In other implementations of the technology, the method being executed at a server in communication with the device.

In some implementations of the technology, identifying device data associated with the device comprises receiving device data from the device. In other implementations of the technology, identifying device data associated with the device comprises retrieving device data from a memory.

According to another broad aspect of the present technology, a method of providing device data relating to a device is provided. The method is executable at a server, the server being coupled to a network, where communication is executed in accordance with a communication protocol model having a plurality of layers. The method comprises receiving, via the network, a first network protocol message from the device, the first network protocol message indicative of an access request to a resource; identifying device data associated with the device, compiling a second network protocol layer message associated with the device, the second network protocol layer message containing the device data; transmitting, via the network, the second network protocol layer message to a second device via a non-application layer of the communication protocol model.

In some implementations of the technology, identifying comprises retrieving device data from the first network protocol message. In other implementations, identifying comprises retrieving device data from a database.

In some implementations of the technology, the first network protocol message is part of the second network protocol message.

In some implementations of the technology, the first network protocol message is encrypted and wherein the second network protocol message that is non-encrypted.

In some implementations of the technology, the second device comprises a web server.

In some implementations of the technology, the first network protocol layer message and the second network protocol layer message comprise a TCP SYN message.

In some implementations of the technology, compiling a second network protocol layer message comprises inserting device data into the first network protocol layer message.

In some implementations of the technology, inserting comprises inserting the device data into a TCP options field of the first network protocol layer message.

According to yet another broad aspect of the present technology, a method of establishing a communication session between a device and a web server is provided. The method includes a step of creating a multi-layer command message. The method comprises augmenting at least one of a plurality of command layer fields of one layer of the multi-layer command message with data that is non native to the one layer, the augmenting being executed at least one of the device and an intermediary server responsible for establishing the communication session.

In some implementations, data is native to another layer of the multi-layer command message.

In yet another aspect of the present technology, a server for providing data relating to a device in a transmission to a web server is provided. The server comprises a processor; a database for storing records relating to the requirements of the server and the device data; and connection analysis software operating on the server providing instructions to the processor executing the methods disclosed herein.

According to other aspects of the present technology, an embodiment provides a system, device, method and applications for transmitting data relating to a requesting device (such as a communication device) to a destination device (such as a web server). In one embodiment, the requesting device may make a connection to the destination device directly. In an alternative embodiment, connection request may be sent by the requesting device to the destination device through one or more intermediary devices. In such an embodiment, the message/data may be modified and/or appended by an intermediary device. For example, when requesting device makes a connection request to the web server, the request may be intercepted at an intermediary server (such as a server managing outbound connection requests for the communication device) and the intermediary server may append additional data relating to the device and/or its account(s) to the request before sending the request to the web server. In one embodiment, the communication device attempts to establish a connection to the web server via a connection in a network transport layer. The intermediary server may append the additional data in an options field in the message.

With some general features of embodiments described, it is noted that another aspect of an embodiment relates to a method of providing encoded data relating to a communication device in a network in a communication protocol model having a plurality of layers. The method comprises: identifying device data associated with an application for a first communication device in an application layer of the protocol model; generating a first message containing the device data; and transmitting the first message to a second communication device in the network in a layer of the protocol model that is not the application layer.

It is noted that another aspect of an embodiment relates to a method of providing encoded data relating to a communication device in a network in a communication protocol model having a plurality of layers. The method comprises: identifying device data associated with an application for a first communication device; generating a first message containing the device data; and transmitting the first message to a second communication device in the network in a layer of the protocol model that is not the application layer.

In the method, a second message may be transmitted from the first communication device following the protocol model, where the second message is related to the first message and contains the device data. The device data in second message is encrypted. Further, the device data in first message may not be encrypted.

For the method, the one of the first message and the second message comprises data non-native to the plurality of layers.

In the method, the second communication device may be a web server.

For the method, the first message may be further transmitted from the second communication device to a third communication device in the network. Alternatively, the one of the first communication device, the second communication device and the third communication device may be a web server.

For the method, once the inserting is completed, content of the first layer message may be updated during a connection session.

For the method, the device data may include authentication information.

The first message may be TCP SYN message. The device data may be encoded in a TCP option field in the first message. The application may be a web browser.

In a second aspect, a method of providing application layer device data relating to a communication device is provided. The method comprises: identifying application layer device data associated with the first communication device; the application layer device data being associated with at least one of a non-application protocol layer function and an application protocol layer function, and inserting the application layer device data into at least one of a plurality of non-application protocol layer fields of a non-application protocol layer message associated with the communication device.

In a second aspect, a server for providing data relating to a communication device in a transmission to a web server is provided. The server comprises: a processor; a database for storing records relating to the requirements of the server and the device data; and connection analysis software operating on the server providing instructions to the processor executing the method as provided in any one of the above noted aspects.

In other aspects, various combinations of sets and subsets of the above aspects are provided.

Additional aspects and advantages of the present disclosure will be apparent in view of the description which follows. It should be understood, however, that the detailed description, while indicating embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

With reference to embodiments thereof, the disclosure will next be described in relation to the drawings, which are intended to be non-limiting examples of various embodiments of the present disclosure, in which:

FIG. 1 is a schematic diagram of a system having a network containing a server and a plurality of website servers hosting websites and a device in communication with the network through the server according to an embodiment;

FIG. 2A is a schematic diagram of representative Open Systems Interconnection (OSI) and Internet network protocol layers for communications processed between two or more devices in the system of FIG. 1;

FIG. 2B is a schematic diagram of contents of a Transmission Control Protocol (TCP) segment used as a data packet in an Internet transmission between devices in the system of FIG. 1;

FIG. 3 is a schematic representation of the device of FIG. 1 and its browsing application according to an embodiment;

FIG. 4 is a schematic representation of the server of FIG. 1 and its connection request application according to an embodiment; and

FIG. 5 is a flowchart of processes executed by devices for an information processing algorithm executed in total by the device, the server and a website server of FIG. 1 according to an embodiment.

### DETAILED DESCRIPTION OF THE DISCLOSURE

Details of example embodiments are provided herein. The description which follows and the embodiments described therein are provided by way of illustration of an example or examples of particular embodiments of principles of the present disclosure. These examples are provided for the purposes of explanation and not limitation of those principles and of the disclosure. In the description which follows, like parts are marked throughout the specification and the drawings with the same respective reference numerals.

Before discussing details on specific features of an embodiment, a description is provided on a network having a device, as a server, that provides connections to other devices, as clients, according to an embodiment. Then, details are provided on an example device in which an embodiment operates.

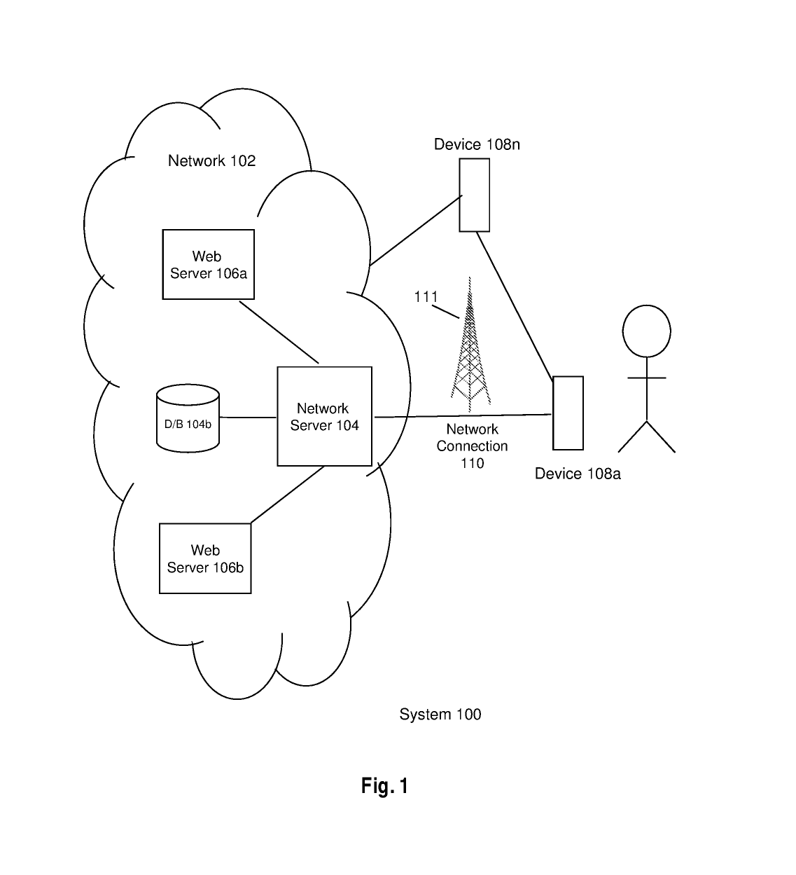

As such first, details are provided on non-limiting embodiments of a network where devices according to an embodiment may operate. Referring specifically to FIG. 1, details on a system of example networks and communication devices according to an embodiment are provided. Within the illustration of FIG. 1, there is provided a system 100. Within system 100, there is provided a server 104 communicatively coupled to a network 102. The server 104 is configured to connect, via the network 102, to other servers, such as a web server 106a and a web server 106b, described later. Naturally, the network 102 may consist of a number of additional servers to which the server 104 may be able to connect.

There is also provided a device 108a, associated with a user (not sedately numbered). It should be noted that the fact that the device 108a is associated with the user does not need to suggest or imply any mode of operation—such as a need to log in, a need to be registered or the like.

The implementation of the device 108a is not particularly limited, but as an example, the device 108a may be implemented as a personal computer (desktops, laptops, netbooks, etc.), a wireless communication device (a cell phone, a smartphone, a tablet and the like), as well as network equipment (a router, a switch, or a gateway). The device 108a comprises hardware and/or software and/or firmware (or a combination thereof), as is known in the art, to access the server 104 via the network 102.

In the specific non-limiting example depicted in FIG. 1, the device 108a is implemented as a wireless communication device and is connected to the network 102 via a network connection 110, which in this non-limiting example is implemented as a wireless network connection. In one non-limiting embodiment, the network connection 110 is provided by a wireless cellular network provider, generally depicted in FIG. 1 as a base station 111. The network 102 may be the Internet or may be configured as an Internet Protocol (IP) network. Other network protocols may be used for other network configurations (e.g. asynchronous transfer mode networks, cellular networks, WLAN, Wi-Fi, etc.).

Naturally, there can be a number of additional devices provided within the system 100, generally depicted as a plurality of devices 108n. The plurality of devices may also access the network 102. The plurality of devices 108n can access the network 102 through wired connection and/or wireless connections. In the specific example depicted, the plurality of devices 108n are configured to have connection to the network 102 while avoiding the network connection 110.

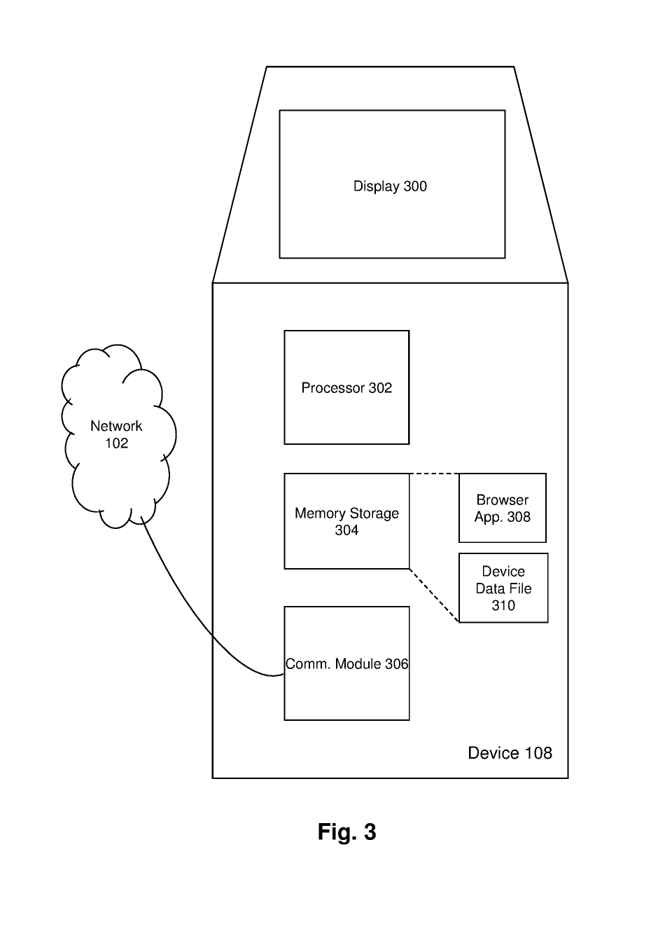

Referring to FIG. 3, an example of the device 108a is depicted. Device 108a is built on a processor-based platform having typical, computing-based components, including a display 300, a processor 302, a memory storage 304, a secondary storage hard drive (not shown) and a communication module 306 (providing necessary hardware, software and firmware components to allow the device 108a to connect to outside networks, such as the network 102). Applications stored in the memory storage 304 provide instructions executed on the processor 302 enabling the processor 302 to control features and functions of the device 108a, receive inputs and process outputs. A browser application 308 generates a set of GUIs on the display 300 and allow inputs to be provided to the GUIs (e.g. from keyboards, mice, touchpads, external devices etc.). Part of the browser application 308 builds connection request messages (e.g. SYN packet) to be described herein below. Features of the browser application 308 may be conducted by other applications in the device 108a. It will be appreciated that the device 108a may be a “thin” or “thick” client to the network 102. Statistics and device configurations for device data (to be described herein below) may be tracked and stored on the device 108 in the memory storage 304. For example a device data file 310 containing capabilities of the device 108a and browsing histories may be stored.

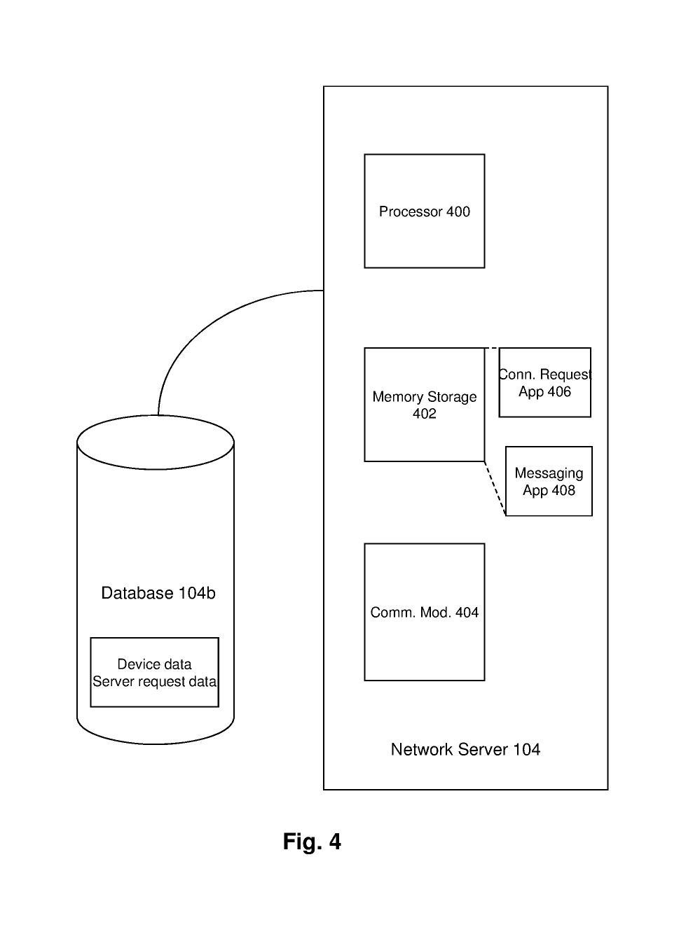

Referring to FIG. 4, an example of the server 104 is depicted. The server 104 is also implemented as a computing device. The server 104 may be a single server or may comprise multiple servers. The server 104 is a processor-based device having a processor 400, a memory storage 402, an access to secondary storage database 104b and a communication module 404 (providing necessary hardware, software and firmware components to allow the server 104 to connect to outside devices and networks, such as the device 108a and the network 102. Applications stored in the memory storage 402 provide instructions executed on the processor 400 enabling the processor 400 to control features and functions of the server 104. Connection request application 406 is stored in the memory 402 and provides instructions to the processor 400 to analyze incoming messages from the devices 108a, access configuration data for connected servers and the devices 108a, identify relevant device data for the received request (to be described below). Messaging application 408 builds the final appended message for transmission by inserting the device data into the request message and forwarding the request message towards the ultimate destination server (to be described in detail below). Connection request application 406 may include algorithms that provide additional messaging and data analysis algorithms described herein. Features of messaging application 408 and connection request application 406 may be interchanged between applications and/or may be conducted by other applications in the server 104 and/or the device 108a. It will be appreciated that other servers may have similar components and modules to those described for the server 104.

As an example of the functionality of the device 108a, the device 108a may request access to various web resources, via the network 102 (and, more specifically, via the server 104). To that end, the device 108a may execute a browser application to establish one or more (Internet) browsing sessions.

In a typical browsing session, a GUI is generated on the display (e.g. a display 300, FIG. 3) of the device 108a through the browser application. For example, a user at the device 108a may access a website through various user-interface systems and input/output devices, such as using a keyboard device to enter an exact website address (e.g. “http://www.test.com”) in a command line in the browser application or activating a hyperlink generated in the web page through an input device (such as a mouse for example) that is connected to the device 108a. Once the request is activated (e.g. by after a web address has been entered in the command line and the “search” or “return” key has been activated for the browser application), the browser application extracts and processes the request, then generates a request for the website and sends it from the device 108a to the server 104 via the network connection 110.

The server 104 is configured to “resolve” the request, or in other words, determine, which one of the web server 106a or the web server 106b (or other web servers potentially present within the system 100) host the requested website and to forward the request to such the web server. In an embodiment, when the device 108a requests a specific website from the server 104, the response provided back to the device 108a may or may not provide access to the requested website. For example, one of the web servers 106a or 106b (or another server in network 102 potentially hosting the specific website) may provide information other than the requested specific website. This other information may be a differently configured website, more or less data (e.g. text, visuals, audio/video clips, etc.) depending on the capabilities and/or configuration of the device 108a, a denial to access the requested website and the like.

In identifying what resource to provide to the device 108a in response to its request, one of the web server 106a or web server 106b (or another server in network 102 potentially hosting the specific website) may evaluate the request and determine whether the device 108a is capable and/or authorized to access the requested website. To assist with the evaluation, one of the web server 106a or web server 106b (or another server in network 102 potentially hosting the specific website) may be have access to configuration/capacity data of the requesting device 108a from the device 108a itself and/or from an intermediary device (such as from server 104 or other sources).

A typical browsing session managed by the browser application operating on the device 108a may have a distinct opening event (e.g. opening of a new browsing window or tab in a graphical user interface—GUI) and may have a distinct closing event (e.g. closing of the window for the session by an action of the user or by the browser itself).

Alternatively, a particular session may have an implied end, for example, the particular session may be deemed to be ended after a certain period of time that the browser session is at a given website (e.g. 15 minutes at the current website displayed in the browser (e.g. www.yandex.com) without any input activity to change the current website by device 108a). A session may be deemed to exist for the time during which a communication connection is active between the requesting device (such as the device 108a) and the server hosting the website (such as one of the web server 106a or web server 106b).

According to embodiments of the present technology, a monitoring application (not depicted) may be installed on the device 108a. Upon receipt of the user consent, the monitoring application is configured to track and monitor browsing sessions associated with the device 108a. The monitoring application is further configured to generate a history log file containing data representative of browsing sessions. The information stored in the history log may be anonymized.

The information stored in the history log may be representative of data relating to each web page visited during a browsing session, including data on when was the session started, how was the session started, what websites were visited, when were the websites visited, what was the duration of staying at each website, how was each website accessed, how did the session end and when did the session end and other recordable items.

Alternatively, the monitoring application can be executed on the server 104. Hence, it can be said, that the data for browsing histories associated with the device 108 and other devices (such as the plurality of devices 108n) may be tracked and/or stored at various locations, e.g. in databases of Internet Search Providers (ISPs), in local browser data files on devices (since some browsers and search engines are integrated applications to provide user with web search feature without visiting a website—e.g. in Chrome™ browser and a Yandex™ browser), in databases of mobile networks, in data stored by browser plug-ins operating on the devices 108 and in other applications installed on the plurality of devices 108n implemented as smartphones and computers.

The server 104 can be configured to collect and amalgamate data from one or more of the different locations and from the device 108a, as well as other ones of the plurality of devices 108n, then process and analyze the so-collected data to identify trends in web-browsing activities from users at the device 108 and the plurality of devices 108n accessing the server 104. Data for browsing histories may be requested and retrieved from various local and remote sources and locations using data acquisition techniques known in the art.

Various physical and logical communication functions within the network 102, server 104 the web servers 106a and 106b, the device 108 and the plurality of devices 108n, are typically organized following a layered model of network functions, such as an Open Systems Interconnection (OSI) model or a TCP/IP model or the like. Open Systems Interconnection (OSI) model or the TCP/IP model are just two examples of a communication protocol model having a plurality of layers.

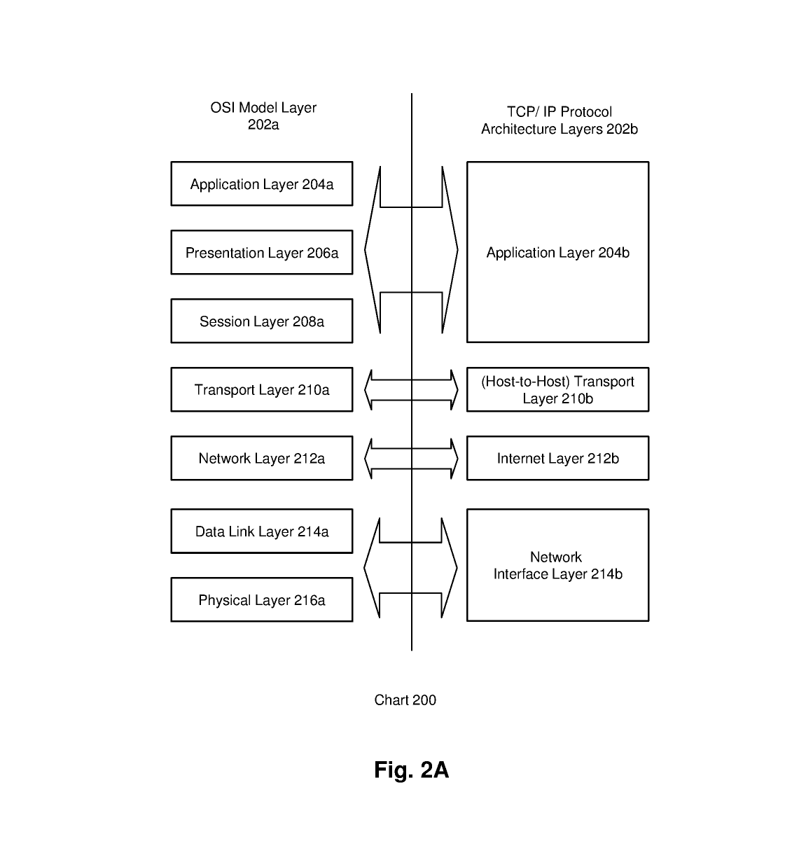

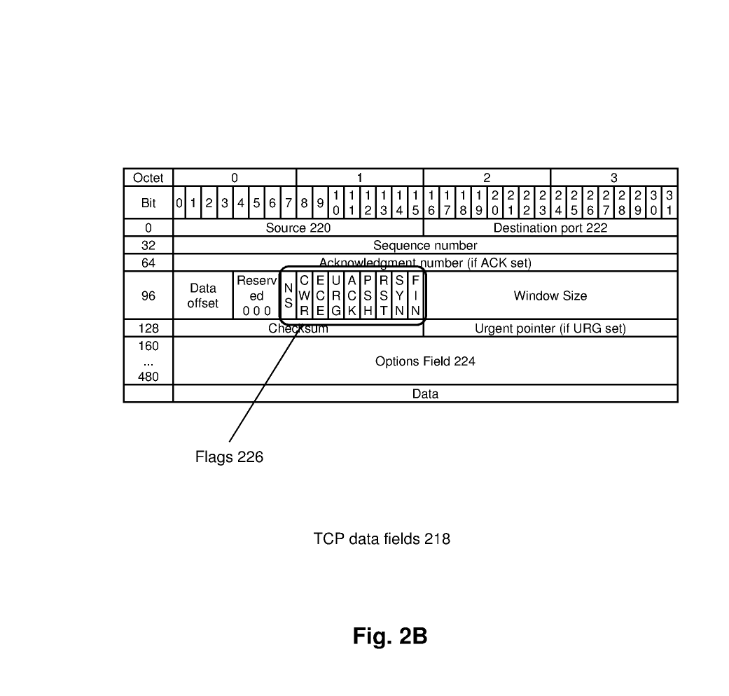

Referring to FIG. 2A, a chart 200 shows diagrammatically layers of an OSI in model of layers 202a and a corresponding TCP/IP model of layers 202b for two network protocol layouts.

The OSI model groups similar communication functions into one of seven logical layers. A layer serves the layer above it and is served by the layer below it. For example, a layer that provides error-free communications across a network provides the path needed by applications above it, while it calls the next lower layer to send and receive packets that make up the contents of that path.

The seven layers are (from top to bottom where the top-most layer is the “most” abstract layer and the bottom-most layer processes with physical connection communications): application layer 204a, presentation layer 206a, session layer 208a, transport layer 210a, network layer 212a, data link layer 214a and physical layer 216a. The physical layer 216a is responsible for the direct point-to-point data connection (not necessarily reliable). The data link layer 214a is responsible for reliable point-to-point connection. The network layer 212a is responsible for addressing, routing and delivery of datagrams between points in a network. The transport layer 210a is responsible for reliable delivery of packets within the network. The session layer 208a is responsible for managing sessions between applications. The presentation layer 206a is responsible for data representation, encryption and decryption, etc. The application layer 204a is responsible for managing network processes to application.

In the TCP/IP model there are typically four layers, namely, application layer 204b (which incorporates functions and features of application layer 204a, presentation layer 206a and session layer 208a from the OSI model), (host-to-host) transport layer 210b (mapping generally to functions and features of transport layer 210a), Internet layer 212b (mapping generally to functions and features of Internet layer 212a) and network interface layer 214b (mapping generally to functions and features of data link layer 214a and physical layer 216a).

In the TCP/IP model Network Interface layer 214b handles processing of TCP/IP packets to and from network 102. Internet layer 212b handles addressing, packaging and routing functions. Transport Layer 210b interfaces with application layer 204b to provide it with session and datagram communication services. Two communication protocols used in transport layer 210b are TCP and User Datagram Protocol (UDP). TCP commands and messages provide a one-to-one, connection-oriented communications services between devices. TCP messages are exchanged to create a TCP connection and manage data packet transmissions for the connection. UDP provides a one-to-one or one-to-many communications service.

In the network 102, ports (and related port numbers) are constructs used to define communication endpoints for an operating system of a device. The identification of ports in a network and the assignment of port numbers allow a server to be uniquely identified in a network to devices in the network and also allow an application stored on the server to be uniquely identified. This unique identification assists in sharing of the related physical connection for the server to other devices in network 102. A port number of a port, when combined with the server's IP address, defines a complete destination address for a communication session for a requesting device. As such, communications from a device may be routed through network 102 to the target server using its specific destination IP address. When the communications are received at the server, they may then be analyzed for their related destination port information to allow them to be routed to the proper process associated with that port number.

Application layer 204b manages access to services of the other layers through various protocols. Application layer communications are in a higher abstraction level compared to communications carried in lower levels (such as communications carried in transport layer protocols). Two example protocols used in application layer 204b include HTTP and HTTPS, which are both used to transfer files for web pages from one source (e.g. a server) to a destination (e.g. a client device). HTTP establishes and manages sessions, which are a sequence of request/response transactions between devices in network 102. A device sends a request and establishes a TCP connection to a particular port on a specific host. A HTTP server (e.g. the web servers 106a or the web server 106b) monitors communications on that port. When the HTTP server receives a request message from the client (e.g. the device 108a), the HTTP server analyzes the request and generates and send a reply message. HTTPS provides authentication of a website and associated web server 106a or web server 106b for communicating with the device 108a. HTTPS provides bi-directional encryption of communications between the device 108a and the respective one of the web server 106a or web server 106b.

FIG. 2B shows a representative data fields 218 of a data package/packet sent using TCP/IP in the network 102. Source field 220 identifies the network address/port of the transmitting source of packet, which may be device 108a. Destination port field 222 identifies the ultimate destination address/port of the packet, which may be a server in network 102. TCP Options field 224 is a variable length data field that is used by an embodiment to store selected device data relating to a device (described in more detail below). Flags 226 are fields for various status flags used to impart connection status information based on a preset understanding among devices as to what values mean what conditions for the respective flag. For example a value of “0” in a field may mean “no” or “not set”; and a value of “1” in a field may mean “yes” or “set”. Text in a field may be extracted and read by the receiving device. Fields for flags 226 may contain data or values for specific information (e.g. port numbers). Use of flags 226 for an embodiment is described below.

One aspect of an embodiment provides a system, method, device and applications that provide data about the device 108a (or one of the plurality of devices 108n) that is making a request to access a website (and as such, a website hosted at the web servers 106a or the web server 106b). Using an example of the device 108a, the data is additional data that may relate to any operating parameter, capability or limitation of the device 108a or account(s) associated with a user(s) of the device 108a. As an example, additional data include, for example, capabilities of the devices 108a (e.g. is it a cellular device, screen size of device 108a, local memory available on device 108a, application installed, current version of operating system, current battery level, current communication connections, etc.), parameters of account(s) (e.g. name of its carrier, parameters of data plan, amount of data left for billing cycle, etc.) of service provider(s) associated device 108a, and any other characteristics on the operating parameters of device 108a and/or account(s) associated with device 108a and/or its current user.

Additional data may include (anonymous) customer reference data, radio access technology (RAT) data, which may provide subscriber connection information for the network provider, International Mobile Security Identity (IMSI) and International Mobile Station Equipment Identity (IMEI) data providing identification data for cellular communication devices, Mobile Subscriber Integrated Services Digital Network-Number (MSISDN) relating to a mobile phone number, device location information, status on the location of device 108a (e.g. roaming, not roaming, current location, current area code, current time zone, etc.), data relating to a current tariff of a subscriber associated with device 108a, etc. The data may include network status data relating to the web server 106a or web server 106b and/or connection 110. Collectively, for this disclosure, this additional data is referred to as “device data”. The term device data includes at least one or more of the types of exemplary additional data described herein and is not meant to be limiting by the examples provided herein. Generally speaking, the device data can be broadly categorized as being associated with at least one of a network protocol layer function and an application protocol layer function.

One aspect of an embodiment determines when device data should be provided to network 102 (in particular to the web server 106a or the web server 106b) and how the device data is to be provided to the network 102. In one embodiment, the device data is inserted into communications sent from the device 108a destined for the web server 106a. In one embodiment, such communications are processed at an intermediate network processing stage by server 104. Server 104 may determine that the device data should be provided to web server 106a.

According to one embodiment of the present technology, device data is provided in communications sent between the device 108a, the server 104 and the web servers (one of the web server 106a and the web server 106b or both). Device data may be sent in one or more (communication) channels between the device 108a, the server 104 and the web servers 106a and 106b. Such communication channels may be processed through one or more network layers using one or more protocols (as described above). For example, device data may also be sent independently in a communication sent between the device 108a, the server 104 and the web servers 106a and 106b. In an application layer protocol (see FIG. 2A, application layer 204b). One embodiment may also have messages that contain device data in fields in HTTP communications sent between the device 108a, the server 104 and the web servers 106a and 106b.

Generally, TCP communications are not encrypted at the source or destination during a HTTP connection session. As such, the server 104, as an intermediary server between the device 108a and the web servers 106a and 106b, is able to intercept TCP communications from the device 108a bound for the web servers 106a or 106b and is able to amend communications to append device data into the communication before it is forwarded to web servers 106a or 106b. Communications that are sent in other layers may also carry the device data, and for those communications, the device data may or may not be encrypted. Naturally, the device data may be inserted into other fields and/or in other communications.

In some cases, server 104 may not be able to intercept and easily add device data in communications sent from device 108a through server 104 to web servers 106 as the communication may be encrypted or signed with an electronic signature. This may be the situation in communications sent in HTTPS communications. Within these embodiments, the device data can be inserted into a transport layer message (see FIG. 2A, transport layer 210b) and, more particularly, TCP Options field (i.e. field 224, FIG. 2B), which is typically not encrypted even within the HTTPS communications. Therefore, it can be said that transport layer message may have a first subset of the plurality of network protocol fields being non-encrypted (such as the TCP Options field) and a second subset of the plurality of network protocol fields being encrypted.

In another embodiment, the device data is inserted into a layer of the OSI Model, to which the data is not native. For example, the device data native to one of the layers may be inserted into a different layer, to which layer it is considered to be non-native.

Furthermore, it is possible that the device data can be split between various layers of the same message. For example, a first portion of the device data may be provided in a transport layer message. Meanwhile, a second portion of the device data may be provided in an application layer message. Likewise, in those embodiments where the device data is too large to fit within one message, the device data may be split between two or more messages.

Device data may also be provided in other fields for other network topologies. For example, in 3GPP wireless networks, device data may be incorporated into communications in a 3GPP header.

According to embodiments of the present technology, the device data about the device 108a may be provided (i.e. determined and inserted into the communications sent to the server 104) by the device 108a itself. Alternatively, device data may be appreciated and inserted into the communication message by the server 104 and/or by other devices/servers. As such, other devices in the network 102 (such as the plurality of devices 108n, for example) may be configured to be another intermediary device to process the message from device 108a to the web server 106a.

In those embodiments, where the server 104 is responsible for appreciating and inserting of device data, to populate the TCP message sent to web server 106a, the server 104 maintains data relating to web servers 106a and 106b and the device 108a, as well as the plurality of devices 108n. Server 104 maintains and/or accesses a database 104b that identifies servers 106 in network 102 (and in other networks) that server 104 is connected to and any special (additional) information requirements requested by such servers. Table A below shows an example of the data in database 104b listing servers 106 in network 102 and their information requirements.

TABLE A

| Device | Data Requirements | Notes |
|---|---|---|
| Server | Type of device | Server 106a may be a web server and |
| 106a | Operating system | access to different forms of its website |
| | of device | may be provided to the requesting device |
| | Display of device | depending on the capabilities of the |
| | | device |
| Server | Status of | Server 106b may be an e-commerce web |
| 106b | user's account | server and access to its website may be |
| | Current | provided only if a user's account for its |
| | location | website is in good standing |
| Device | Applications | Device 108n may be another |
| 108n | installed in | communication device. Peer-to-peer |
| | device | communications may be provided only if |
| | | certain application(s) are installed on the |
| | | requesting device. |
| . . . | . . . | . . . |

Additionally or alternatively, the server 104 may maintain and/or access database 104b that identifies the device 108a and the plurality of devices 108n and related accounts that server 104 is connected to and related device data. The data in database 104b may be stored in one or more physical or virtual data storage locations accessible by server 104. The server 104 may additionally or alternatively generate and send request(s) for information from any server present within the network 102 (or other connected networks for that matter) for details on its specific additional information requests and information from any device 108a or plurality of devices 108n for details on its specific device data. Table B below shows an example of the data in database 104b listing device 108a and/or plurality of devices 108n that are associated with the server 104 and their capabilities.

TABLE B

| Device | Exemplary Device Data |
|---|---|
| Device 108a | Operating system: 3.2 |
| | RAM: 4 GB |
| | Display: 4″/TFT |
| | Applications installed: N/A |
| | Current location: N/A |
| | Service provider: AT&T |
| A device from | Operating system: 1.2 |
| the plurality | RAM: N/A |
| of devices | Display: N/A |
| 108n | Applications installed: |
| | google maps |
| | Abode Flash |
| | Current location: New York |
| | Service provider: AT&T |
| . . . | . . . |

In an example embodiment of the present technology, it shall be assumed that the device 108a may generate and send its message with the device data to a first intermediary device, which then receives and forwards the message (or generates a new message containing at least the device data from the original message) and sends a message to a subsequent device (which may be the web server 106a or may be a further intermediary device in the connection path toward web server 106a). Whether the communication path for the message between the device 108a and the web servers 106 is direct or indirect (i.e. passing through at least one intermediary device), may be determined by a network manager for network 102 (such as the server 104), network traffic algorithms, network communication protocols, the device 108a and/or the web server 106a.

Further details are provided on an example of the processes in an embodiment that provides device data (e.g. relating to device 108a and/or an account associated with a user of the device 108a) to a server of a website (e.g. the web server 106a or the web server 106b). To illustrate features of an embodiment, details are provided where a user (or users) of the device 108a decides to visit a website hosted by the web server 106a (which description would equally apply to the embodiment where the website is hosted by the web server 106b). For this example, web server 106a is hosting a website using destination port 443, which is reserved for HTTPS, and web server 106a is assigned illustrative IP address 1.2.3.4. It shall be assumed that the user has entered a URL associated with the website she is attempting to visit using a browser application running on the device 108a.

First, the operating system on the device 108a is attempting to establish a connection to the web server 106a, by creating and sending to the network 102 a TCP message with a synchronization message, such as using a SYN flag set on IP address 1.2.3.4 at port 443.

Server 104 (as an intermediary device in the connection between the device 108a and one of the web server 106a and the web server 106b) receives the TCP message and identifies the source and/or its final destination ports (e.g. by extracting and analyzing data in fields 220/222 (FIG. 2B) of the incoming TCP message and identifying the destination address of the message, here IP address 1.2.3.4).

At the web server 106a, the final destination may have operating parameters where additional data may be required or requested about devices that are seeking to connect it.

In one embodiment, the device 108a provides its device data in its TCP message that it sent to server 104. In another embodiment, server 104 provides (at least part of) the device data relating to device 108a in a TCP message that forwards to web server 106a, based on the TCP message that it received from device 108a. Server 104 analyzes the received TCP message from device 108a to determine if the destination (e.g. web server 106a) has requested that device data relating to the sender (i.e. device 108a) should be collected and provided to web server 106a. This may be monitored by server 104 by maintaining and setting device data request flags for web server 106a.

Once the server 104 identifies whether the web server 106a is seeking (or is capable of processing) the device data from the device 108a and if so, what types of the device data, and provided that such device data has not been inserted into the message by the device 108a itself, then the server 104, obtains a copy of the device data (e.g. from its database 104b) and builds a message packet for insertion into a message to be sent to the web server 106a.

If specific data requested by the web server 106a is not provided in the database 104b, the server 104 may attempt to locate alternative device data from other sources, e.g. by conducting searches of other databases (not depicted). Additional device data may be provided by the server 104 to the web server 106a even if such additional device data was not expressly requested.

Alternatively or additionally, the server 104 (or another device) may generate and send a request to the device 108a (or a database of its service provider) for the specific device data. In such a situation, the device 108a would receive the request, review its data and send a response providing any locally available device data is available. When response(s) are received by the server 104, the requested data may be incorporated as part of the device data for the device 108a.

Thereafter, the server 104 attaches to a message the device data and sends the message to the web server 106a. In one embodiment, recalling that the device 108a provided its message as a TCP message destined for the web server 106a, the server 104 builds on top of that original message and inserts the device data into a field in a TCP header, such as in the TCP Options field.

As the Internet Address Naming Authority (IANA) has allocated the number “123” to identify such a TCP options, the Server 104 may append the device data to a header of the SYN packet message to the IP address 1.2.3.4 port 443 the TCP Options with code 123, where the contents point to the device data. For example, the server 104 may send anonymous caller identification (ID) as a number. The packet is sent from the server 104, through the network 102, reaches the Internet (shown as network 102) and then reaches the web server 106a (having IP address 1.2.3.4). The “options-kind”, “options-length” and “options-data” fields may be used and set in various configurations to permit multiple fields of device data to be provided in a transmission. Device data may be provided as text and/or recognized coded short forms. Table C below shows an example of a set of data provided in Options field 224 (FIG. 2B) for the device data associated with the device 108a:

TABLE C

| Device Data for Device 108a | Options Field Short Form |
|---|---|
| Operating system: 3.2 | OS: A (code for 3.2) |
| RAM: 4 GB | RAM: 4 |
| Display: 4″/TFT | Display: 4A (code for 4″/TFT) |
| Applications installed: N/A | Apps: 0 |
| Current location: N/A | Location: 0 |
| Service provider: AT&T | Service: 1 (code for AT&T) |
| . . . | . . . |

The TCP Options field may be segregated into static sub-fields for embodiments where specific locations in the TCP Options field are reserved to contain specific device data (e.g. bits 160-168 are reserved for operating system version data; bits 169-180 are reserved for display type data, etc.). Alternatively or additionally, the data in the TCP Options field may be prepended with an identification label known in the system so that the server 104 and the web server 106a (and other devices) can determine what the device data relates to and what its value is.

It should be expressly understood that one or more processes executed by the server 104 as described herein relating to analyzing a message from the device 108a, analyzing requirements of web servers 106a and 106b, analyzing device data of the device 108a and populating the message with appropriate device data may be conducted by any one or more of the device 108, the plurality of devices 108n, the web servers 106a or the web server 106b, or another device/server in the network 102.

Next, web server 106a receives the packet, reads device data from the field in the TCP Options with code 123 and may save the device data locally for further analysis and processing. Web server 106a then may generate and send a response to connection requests by transmitting a packet with a SYN/ACK message. Other types of messages may be used in the TCP communications.

When the web server 106a analyzes the extracted device data, depending on the analysis, the web server 106a may allow/disallow or modify the connection request. For example, if the device data is deemed to be deficient or incomplete, the web server 106a may decide to not establish the requested connection for the device 108a. In that situation, the web server 106a may generate and send a reply to the SYN packet with a failure (which may be noted by setting an RST flag) or the SYN packet may simply be discarded with no reply sent. If there are deficiencies, but they are deemed to not be critical, the web server 106a may still establish the requested connection, but there may be restrictions and/or modifications made to the connection established. For example, some settings and parameters of the website hosted by web server 106a may not be provided to the device 108a. For example, if the device data indicates that the device 108a is a cellular device having a large display (e.g. larger than 5 inches diagonally), then the web server 106a may provide device 108a with access to a website formatted for such displays. As another example, if the device data indicates that there is a bandwidth limitation on the account associated with a user of the device 108a, then the web server 106a may provide device 108a with access to a simplified website that has lower resolution graphics and images compared to a “standard” website.

Table D below shows an example of actions that may be executed by the web server 106a depending on what device data is provided to it in a connection request received from the server 104:

TABLE D

| Requested Information | Exemplary Actions |
|---|---|
| Operating system | If the operation system is not at |
| | least version 3, deny the request |
| RAM | If the RAM is below 2 GB, deny the request. |
| | If the RAM is between 2 and 4 GB, |
| | provide access to a basic website. |
| | If the RAM is above 4 GB, provide |
| | access to an enhanced website. |
| Display | If no display information provided, |
| | request information from device |
| Applications installed | If the Abode flash is not installed, |
| | provide access to the basic website. |
| | If Abode flash v. 10 or higher is installed |
| | provide access to the full website. |
| Current location | If no location information provided, |
| | request information from device |
| . . . | . . . |

An embodiment provides data checking and error detection correction for the device data. As the device data is transmitted with the initializing connection request, the web server 106a may analyze the request and parameters of the requesting device (such as the device 108a) together. If the device data field is empty, an embodiment may assume that the server 104 did not successfully import the device data into the request or that the server 104 intentionally provided an empty field. This discrepancy may be addressed by the web server 106a by means of establishing a separate communication with the server 104 to inquire and determine if there was an error with appending the device data into the request message from the device 108a. This separate communication may be conducted through a communication and messages sent through the application layer level between the server 104 and the web server 106a.

It is noted that an embodiment may provide device data from the device 108a to the web server 106a through multiple channels and communication links. For example, the same device data and/or additional device data that is provided to the web server 106a through device data in the TCP options field in a TCP message may be provided through UDP messages and/or HTTP/HTTPS messages. It will be seen that TCP and UDP messages are transport layer messages, while HTTP/HTTPS messages are application layer messages, so there are different communication protocols used for each message. As a further example, some device data may provided to the web server 106a as a HTTP/HTTPS message and depending on what information is ultimately received at the web server 106a, additional device data may be requested by the web server 106a from the device 108a and such additional device data may be provided to the web server 106a in a TCP options field of a subsequent TCP message. Alternatively, a TCP message may be sent first, which may conditionally be followed by a HTTP/HTTPS message.

In another embodiment, periodically and/or episodically device 108a and/or the server 104 may check their local databases to see if there has been any change in any previously provided device data. Such checks may be conducted when there is a change in status of the device 108a with respect to the server 104 (e.g. device 108a moves to another location, the signal strength of the connection 110 is stronger/weaker, etc.). If there has been a change, device 108a and/or the server 104 may generate and send a device status update message to the web server 106a. Such an update may be triggered after a connection has been established, where the web server 106a provides a message to the device 108a and/or the server 104 that further updated device data is requested regarding the device 108a. This subsequent update may be carried in transport layer communications (e.g. another TCP message) and/or in application layer communications (e.g. through HTTP commands).

In another embodiment, device 108a may be providing device data to the server 104 that relates to a status of a second device (e.g. one of the plurality of devices 108n) that is in communication with the device 108a. This device data for the second device (e.g. one of the plurality of devices 108n) may be provided to the web server 106a using techniques described herein. Followup status messages regarding the current status of the second device (e.g. one of the plurality of devices 108n) may also be provided as described above for the device 108a.

In another embodiment, features regarding message processing, data analysis and message building as described for the web server 106a may be distributed among many servers and devices within system 100. One embodiment may have device 108a incorporate one or more of the noted features of the web server 106a. Another embodiment may have the server 104 incorporate one or more of the noted features of the web server 106a.

It will now be appreciated that given the architecture of FIG. 1, it is possible to execute a method for providing device data, implemented in accordance with non-limiting embodiments of the present technology. The method may be conveniently executed at an intermediary server (such as the server 104) in communication with the client device (such as the device 108a) and the web server 106a or 106b. Alternatively, the method may be conducted at the web server (such as the web server 106a or 106b). The method includes inserting device data into one or more messages exchanged between the various devices within the system 100. For example, the method includes inserting the device data into the transport layer message that may be transmitted in a transport layer in the network 102. Additional device data may be carried in an application layer message in the application layer in the network 102.

In another aspect, an intermediary server (such as the server 104) for providing device data relating to the device 108a in a transmission to the web server 106a or 106b is provided, comprising: a processor; a database for storing records relating to the requirements of the web server 106a or 106b and the device data; and connection analysis software operating on the intermediary server providing instructions to the processor executing the method as provided in any one of the aspects noted herein.

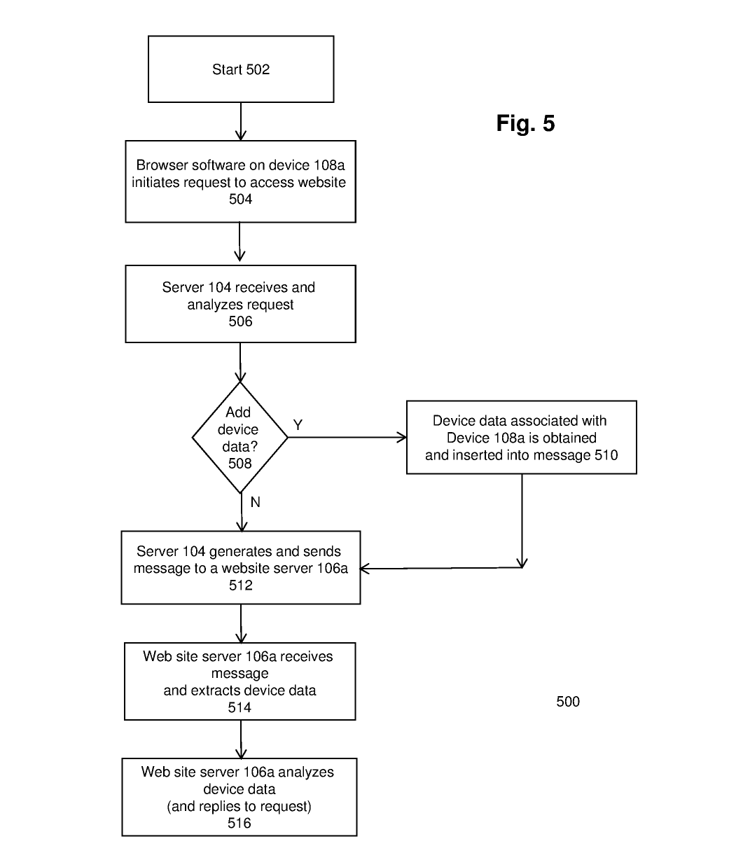

Referring to FIG. 5, there is depicted a flow chart of a process 500 implemented in accordance with non-limiting embodiments of the present technology. The process 500 can be conveniently executed by the server 104. Alternatively, the process 500 can be executed by one of the web server 106a or the web server 106b.

Process 500 begins with an environment where the device 108a has their browser application running thereon.

After start process 502, the device 108a initiates a request to access a website through its browser application at process 504. Device 108a may (or may not) provide some device data (relating to it or another device) in the request message.

As noted earlier this may be achieved by generating and sending a SYN packet from the device 108a to the network 102 (e.g. by setting the SYN flag 226 of FIG. 2B for the packet being sent). At process 506, the server 104 receives the connection request and analyzes its contents.

At processes 508 and 510, the server 104 evaluates the contents of the request message and identifies the server (e.g. web server 106a or web server 106b) associated with the destination of the request. Based on database searches, the server 104 may determine what device data that the web server 106a or the web server 106b is seeking (generally) and identify and collect device data (relating to the devices 108a and/or other devices from the plurality of devices 108) to wholly or partially provide information to satisfy the information sought.

In one embodiment, the server 104 may simply identify the device data and insert all or part of it into the message header. If no additional information is sought, then the server 104 moves from process 508 to process 512 to generated and forward the request message to the network 102 (and the website server 106a or the web server 106b). If additional information is sought, then at process 510, the server 104 obtains device data in order to respond to the request and populates the device data into the message header.

Then the server 104 moves from process 508 to process 512 to generate and forward the request message to the network 102 (and the web server 106a or the web server 106b) with the device data in the header. After the message is sent from the server 104, at process 514, the web server 106a or the web server 106b (as the case may be) receives the message and extracts the device data that is (or is not) contained therein. At process 516, the web server 106a or the web server 106b (as the case may be) analyzes the device data (or lack thereof) and then provides a response to the connection request depending on the analysis. The response may provide the connection, deny the connection or provide a different set of resources or connection to the request in view of the device data provided. In some configurations, providing the response message in process 516 may be omitted.

It will be appreciated that in other embodiments the order of processes in process 500 may be re-arranged and additional processes may be provided. For example, after process 504 but prior to 506 the device 108a may save some device data (relating to it or another device) in the memory storage 304.

Process 500 is shown as executing in part on the device 108a, the server 104 and the web server 106a or 106b, but parts of its execution may be distributed among many servers/devices. Process 500 may be initiated by any one of the device 108a or the plurality of devices 108n, the server 104 and/or web server 106a or web server 106b.

It will be appreciated that the embodiments relating to client devices, server devices and systems may be implemented in a combination of electronic modules, hardware, firmware and software. The terms web server, device and intermediary server used herein are used for convenience only. One or more functions of any of a web server, intermediary server and/or device may be incorporated into other devices described herein. The firmware and software may be implemented as a series of processes, applications and/or modules that provide the functionalities described herein, typically by providing instructions for execution on a related processor. The instructions may be stored in a memory storage device on either or both of the client or server devices that is accessible by the processor. The computer instructions may be provided on a computer-readable medium. In one embodiment, the computer-readable medium is non-transitory. Typically, the memory device is locally located in the same device (or near to the same device) housing the processor. The modules, applications, algorithms and processes described herein may be executed in different order(s) and in parallel. Interrupt routines may be used. Data, applications, processes, programs, software and instructions may be stored in volatile and non-volatile devices described and may be provided on other tangible medium, like USB drives, computer discs, CDs, DVDs or other substrates herein and may be updated by the modules, applications, hardware, firmware and/or software. The data, applications, processes, programs, software and instructions may be sent from one device to another via a data transmission.

As used herein, the wording “and/or” is intended to represent an inclusive-or. That is, “X and/or Y” is intended to mean X or Y or both.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of providing device data relating to a device, the method comprising:
identifying device data associated with the device,
compiling a network protocol layer message associated with the communication device, the network protocol layer message having a plurality of network protocol layer fields, a first subset of the plurality of network protocol fields being non-encrypted and a second subset of the plurality of network protocol fields being encrypted; and
inserting the device data into at least one of said first subset of the plurality of the network protocol layer fields, said inserting enabling incorporation of the device data into the encrypted network layer message.

2. The method of claim 1, wherein the transport layer message is a TCP SYN message.

3. The method of claim 2, wherein the at least one of said first subset of the plurality of the network protocol layer fields is a TCP Options field.

4. The method of claim 3, wherein the method further comprises segregating the TCP Options field into a plurality of sub-fields each of the plurality of sub-fields being reserved for specific portion of the device data.

5. The method of any one of claims 3 to 4, wherein:
data in the TCP Options field is prepended with an identification label for the device data.

6. The method of any one of claims 1 to 5, wherein compiling comprises inserting a portion of the device data into the network protocol layer message, the method further comprising generating a second network protocol layer message containing a remainder of the device data.

7. The method of claim 1, said method being executed at the device.

8. The method of claim 1, said method being executed at a server in communication with the device.

9. The method of claim 8, wherein said identifying device data associated with the device comprises receiving device data from the device.

10. The method of claim 8, wherein said identifying device data associated with the device comprises retrieving device data from a memory.

11. A method of providing device data relating to a device, the method executable at a server, the server being coupled to a network, where communication is executed in accordance with a communication protocol model having a plurality of layers, the method comprising:
receiving, via the network, a first network protocol message from the device, the first network protocol message indicative of an access request to a resource;
identifying device data associated with the device,
compiling a second network protocol layer message associated with the device, the second network protocol layer message containing the device data;
transmitting, via the network, the second network protocol layer message to a second device via a non-application layer of the communication protocol model.

12. The method of claim 11, wherein said identifying comprises retrieving device data from the first network protocol message.

13. The method of claim 11, wherein said identifying comprises retrieving device data from a database.

14. The method of claim 11, wherein said first network protocol message is part of the second network protocol message.

15. The method of claim 14, wherein said first network protocol message is encrypted and wherein the second network protocol message that is non-encrypted.

16. The method of claim 11, wherein the second device comprises a web server.

17. The method of claim 11, wherein said first network protocol layer message and said second network protocol layer message comprise a TCP SYN message.

18. The method of claim 17, wherein said compiling a second network protocol layer message comprises inserting device data into the first network protocol layer message.

19. The method of claim 18, wherein said inserting comprises inserting said device data into a TCP options field of the first network protocol layer message.

20. A method of establishing a communication session between a device and a web server, the method including a step of creating a multi-layer command message, the method comprising:
augmenting at least one of a plurality of command layer fields of one layer of the multi-layer command message with data that is non native to the one layer, said augmenting being executed at least one of the device and an intermediary server responsible for establishing the communication session.

21. The method of claim 20, wherein data is native to another layer of the multi-layer command message.

22. A server for providing data relating to a device in a transmission to a web server, the server comprising:
a processor;
a database for storing records relating to the requirements of the server and the device data; and
connection analysis software operating on the server providing instructions to the processor executing the method as provided in any one of claims 1 to 21.
